(19) United States
(12) Patent Application Publication
(10) Pub. No.: US 2002/0129336 A1
(43) Pub. Date: Sep. 12, 2002

(54) Automatic symbol table selection in a multi-cell environment

(76) Inventors: Joe D. Bolding, Allen, TX (US); Daniel G. Tormey, Richardson, TX (US); Gerald L. Everett, Alta, CA (US)

Correspondence Address: HEWLETT-PACKARD COMPANY, Intellectual Property Administration, P.O. Box 272400, Fort Collins, CO, 80527-2400, US

(21) Appl. No.: 09/740,601

(22) Filed: Dec. 19, 2000

(51) Int. Cl. G06F 9/44

(52) U.S. Cl. 717/124

(57) ABSTRACT

A method of selecting a symbol table includes providing a plurality of symbol tables in a computer system having an address pointer. Each of the symbol tables encompasses a range of addresses. The method also includes identifying at least one of the plurality of symbol tables within whose range of addresses the address pointer is pointing, and selecting the at least one of the plurality of symbol tables.

### FIELD OF THE INVENTION

This invention relates to software debugging on computer systems and more specifically to a method of automatically selecting a symbol table during debugging in a multi-cell computer system.

### BACKGROUND

Debugging tools are used during the programming of almost all software. Debugging tools are used to monitor and modify variables and registers such as the program counter, and to display the source code of the program as the computer processor executes it. The programmer can use these tools to step through a computer program slowly to see what the program does at each instruction, making it much simpler to locate errors or bugs. Debugging tools are used for software written in both low level computer languages, such as Assembly, and high level languages, such as C. For example, software written in a high level language, such as C, is relatively easy to understand and read. However, before software can be executed by a computer, it must be compiled into machine language, which is much more difficult to understand and read. Software in machine language format consists of a string of numbers corresponding to instructions in the computer processor's instruction set combined with numbers to be manipulated by the processor. Functions cannot be located in the software by name, but must be located by address in the computer's memory. Variables cannot be located by name, but must be found either by address in the computer's memory or in one of the few storage registers in the computer processor. The compiled software must also be linked before it can be executed, which links or combines all the functions included in a complex program into a single group, assigning each function a location in the computer's memory and storing those function locations in the software everywhere a function is called. The resulting compiled and linked program code looks nothing like the original program code written in a high level language. It would be extremely difficult and cumbersome, if not impossible, to debug the software in machine language form.

Debugging tools therefore allow the programmer to step through the program in the original programming language, to monitor variables with their original names or to jump to functions with their original names, ignoring their actual location in memory. Debugging tools correlate high level instruction lines, variables, functions, etc, with their machine language counterparts through symbol tables. A symbol table is basically a lookup table containing the addresses in the computer's memory corresponding to each line of high level code, each variable, each function entry point, etc. The symbol table is typically created during the linking process when the addresses for functions and variables are determined.

However, difficulties arise when the program is moved in memory from the location specified during the linking process. When the program is moved in memory, the addresses in the symbol table are no longer correct. This problem is typically overcome by manually calculating an address offset and instructing the debugging tools to add the address offset to the addresses in the symbol table during the debugging process. However, manually calculating and entering address offsets is cumbersome and time consuming. These offsets may need to be recalculated frequently if the program is moved about in memory each time it is executed or during execution.

This difficulty is particularly important when debugging software in a multi-cell computer system. A multi-cell computer system has multiple processing cells, each having one or more processors, input/output (I/O) devices, and other computer components grouped together. Each cell may have its own memory or may share a common memory with other cells in the multi-cell computer system. Therefore, a software program running on a multi-cell computer system can be running on any of a number of different cells, each having their own processors and having the software program loaded at a different memory location. The addresses in the symbol tables must be modified frequently when debugging in a multi-cell environment, since the cell which will execute the program is not typically known during the linking process.

Consequently, a need exists for a method of locating symbols in memory during the debugging process. A need further exists for a method of locating symbols in memory in a multi-cell environment.

### SUMMARY

To assist in achieving the aforementioned needs, the inventors have devised a method of automatically selecting a symbol table in a multi-cell computer. A group of symbol tables are stored in a symbol table set, including base symbol tables and offset symbol tables. The offset symbol tables are base symbol tables which are relocated into memory locations other than the original memory locations selected during linking. Each offset symbol table is intended for use with a particular processing cell in the multi-cell computer. A preferred embodiment of the method for automatically selecting a symbol table includes first determining whether the program counter of the active cell is pointing to an address within one of the base symbol tables, and if so, selecting that base symbol table. If the program counter is not within a base symbol table, the offset symbol tables for the cell executing the program are examined. If the program counter is pointing to an address within one of these, that offset symbol table is selected.

This method allows multiple symbol tables to be offset at different memory locations for different cells in a multi-cell computer. The proper symbol table may then be automatically selected for use with a debugger.

The invention may comprise a method of selecting a symbol table. The method includes providing a plurality of symbol tables in a computer system having an address pointer. Each of the symbol tables encompasses a range of addresses. The method also includes identifying at least one of the plurality of symbol tables within whose range of addresses the address pointer is pointing, and selecting the at least one of the plurality of symbol tables.

The invention may also comprise an apparatus for automatically selecting a symbol table in a computer having a program counter and a plurality of symbol tables. The apparatus includes at least one computer readable storage medium and computer readable program code stored on the at least one computer readable storage medium. The computer readable program code includes code for identifying one of the plurality of symbol tables wherein the program counter in the computer contains an address within the identified symbol table. The computer readable program code also includes code for selecting the identified symbol table.

The invention may also comprise a debugging apparatus. The debugging apparatus includes a computer with a plurality of symbol tables stored thereon and a debugger connected to the computer. The debugging apparatus also includes automatic symbol table selection means for automatically selecting at least one of the plurality of symbol tables in the computer for the debugger.

The invention may also comprise an apparatus for automatically selecting a symbol table in a computer. The apparatus includes at least one computer readable storage medium with computer readable program code stored thereon. The computer readable program code includes code to be executed on a computer having a plurality of processing cells and having a plurality of symbol tables stored thereon. Each of the plurality of symbol tables has a cell identification to indicate for which of the plurality of processing cells it is intended. The computer readable program code also includes code for selecting at least one symbol table which is intended for use with the processing cell which is executing the computer readable program code.

BRIEF DESCRIPTION OF THE DRAWING

Illustrative and presently preferred embodiments of the invention are shown in the accompanying drawing, in which:

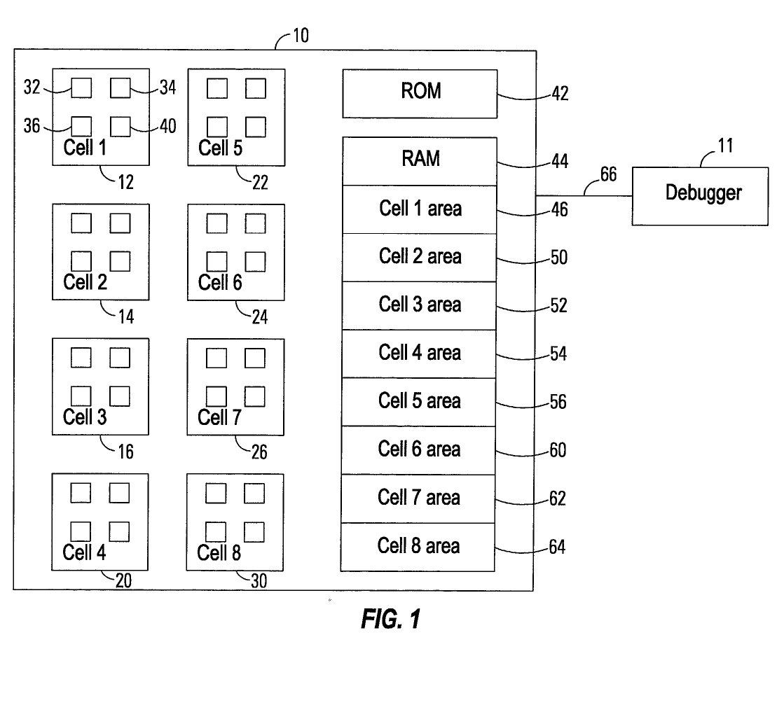

FIG. 1 is a block diagram of a debugger attached to a multi-cell computer system having a single shared global RAM;

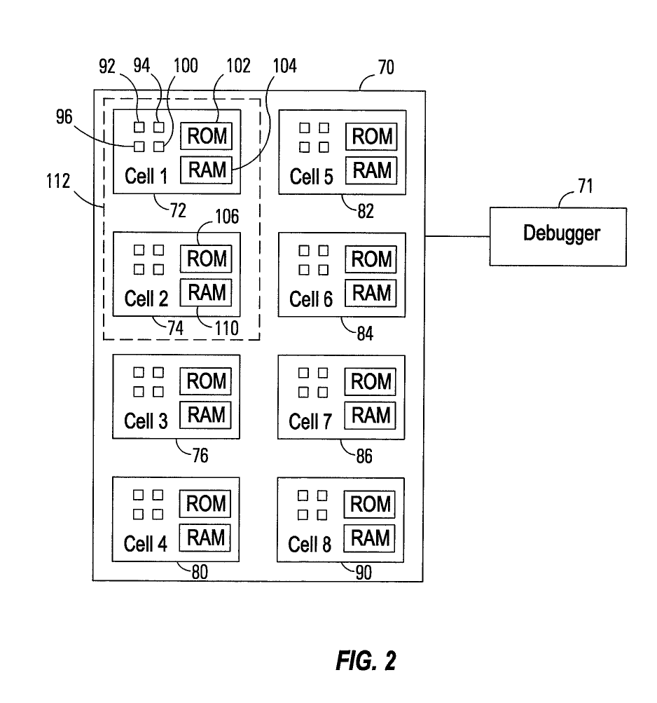

FIG. 2 is a block diagram of a debugger attached to a multi-cell computer system in which each cell has private RAM;

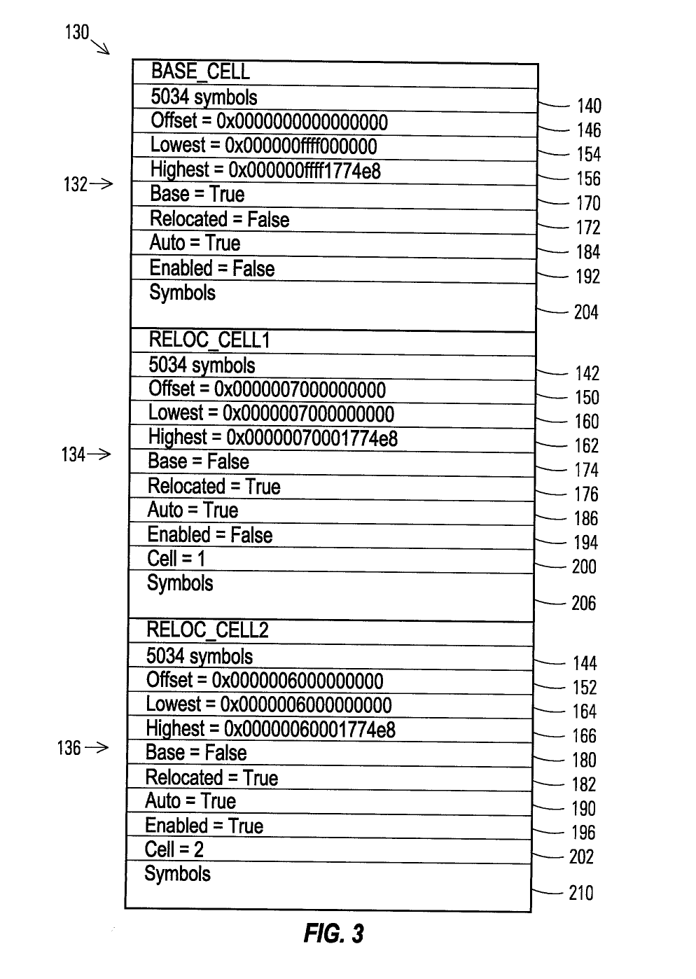

FIG. 3 is a block diagram of a symbol table set; and

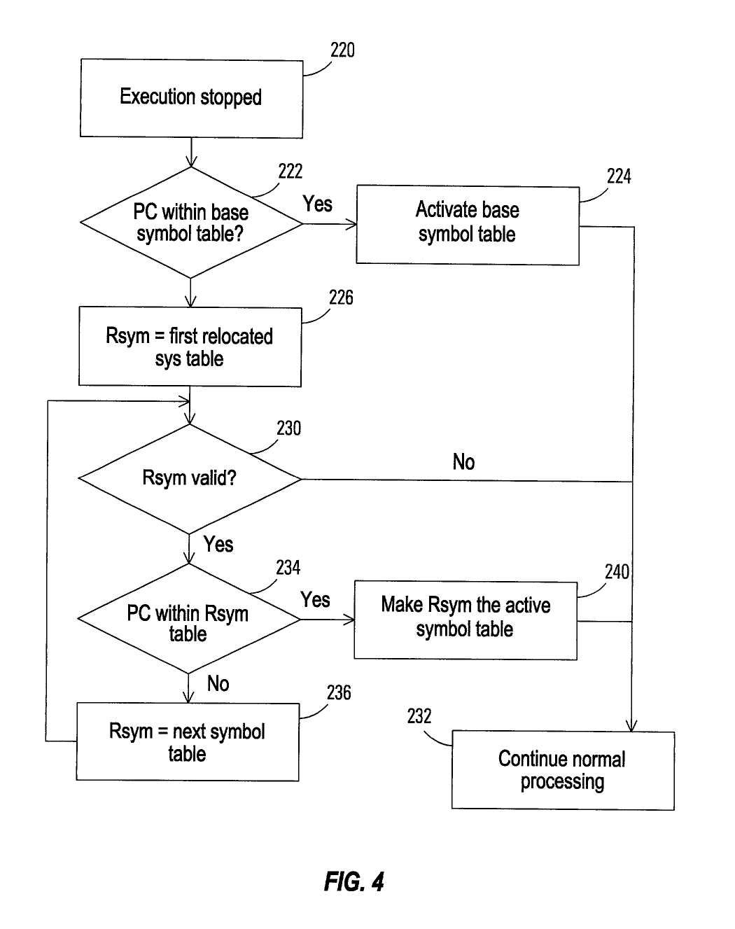

FIG. 4 is a flow chart of a method to automatically select a symbol table set in the multi-cell computer system of FIG. 1.

### DESCRIPTION OF THE PREFERRED EMBODIMENT

The drawing and description, in general, disclose a method of selecting a symbol table. The method includes providing a plurality of symbol tables in a computer system having an address pointer. Each of the symbol tables encompasses a range of addresses. The method also includes identifying at least one of the plurality of symbol tables within whose range of addresses the address pointer is pointing, and selecting the at least one of the plurality of symbol tables.

The drawing and description also disclose an apparatus for automatically selecting a symbol table in a computer having a program counter and a plurality of symbol tables. The apparatus includes at least one computer readable storage medium and computer readable program code stored on the at least one computer readable storage medium. The computer readable program code includes code for identifying one of the plurality of symbol tables wherein the program counter in the computer contains an address within the identified symbol table. The computer readable program code also includes code for selecting the identified symbol table.

The drawing and description also disclose a debugging apparatus. The debugging apparatus includes a computer with a plurality of symbol tables stored thereon and a debugger connected to the computer. The debugging apparatus also includes automatic symbol table selection means for automatically selecting at least one of the plurality of symbol tables in the computer for the debugger.

The drawing and description also disclose an apparatus for automatically selecting a symbol table in a computer. The apparatus includes at least one computer readable storage medium with computer readable program code stored thereon. The computer readable program code includes code to be executed on a computer having a plurality of processing cells and having a plurality of symbol tables stored thereon. Each of the plurality of symbol tables has a cell identification to indicate for which of the plurality of processing cells it is intended. The computer readable program code also includes code for selecting at least one symbol table which is intended for use with the processing cell which is executing the computer readable program code.

Automatic symbol table selection greatly simplifies the process of debugging software that is relocated in memory, particularly in a multi-cell computer system. Debugging software requires a debugger, a tool which can stop the computer processor and step through the software slowly. During the debugging process, the software is loaded into the computer memory in machine language form, a series of ones and zeros representing machine language instructions for the computer processor. Typically a hardware debugger is connected to the target computer, although software debuggers are available. Both types of debugger may benefit from automatic symbol table selection.

A hardware debugger includes a specially wired computer processor which is attached to the target computer, replacing the existing computer processor. The specially wired debugger processor is the same type as the processor in the target computer it replaces, but it is wired to provide external control over the processor. This allows the debugger to halt the processor and execute software slowly.

A symbol table is then loaded into a memory that is accessible by the debugger. If a software debugger is used, the symbol table is loaded in the memory of the target computer. If a hardware debugger is used, the symbol table is typically loaded in the debugger's memory. A typical symbol table includes addresses indicating the location in memory of software elements such as functions and variables. (In some cases, only global variable locations are included since local variables are often placed in temporary memory locations such as in registers or on the stack.) Symbol tables may also include the original source code for the software with the address or addresses in memory for each line of code. Source code is often left out of symbol tables when the software is written in a low-level language such as Assembly, since machine language code can be translated into Assembly language by the debugger. Other details of the symbols in symbol tables will not be discussed in further detail herein, since the automatic selection of a symbol table is not dependent upon the type or structure of the symbols, and typical symbol tables are well known to computer programmers.

Once the software and symbol tables are loaded, the debugger is used to control execution of the software. For example, the debugger can cause the target computer to execute the software instruction by instruction, stopping after each instruction is completed. The debugger can also cause the target computer to execute the software normally until a certain instruction is reached, then stop execution. Each time software execution is stopped, the debugger can be used to monitor or modify the values in variables, to jump to a different part of the software, or to do many other actions useful for evaluating software behavior.

The debugger accesses a given variable by reading the address of the variable in memory from the symbol table, then looking in the computer's memory at that address. The debugger can also display the current line of source code being executed by reading the value of the program counter in the target computer. The program counter contains the address in the computer's memory of the currently executing instruction. If the source code for the software is stored in the symbol table, the debugger can look up the currently executing address in the symbol table to display the currently executing line of source code. If the source code for the software is not stored in the symbol table, the debugger can read the machine language instruction in the computer's memory pointed at by the program counter and translate it into Assembly language for display.

The addresses for items in a symbol table are typically determined when the software is linked. Thus, before the programmer links the software to create an executable program, the programmer must know where the program will be located in memory when executed. If the program is relocated in memory, or loaded into a different location in the computer's memory than indicated during linking, an offset must be added to the addresses in the symbol table. Automatic symbol table selection greatly simplifies and speeds up the process of using a symbol table for relocated software.

To enable automatic selection of symbol tables, a symbol table set is created which contains one or more base symbol tables and one or more secondary symbol tables for a software program. The base symbol tables are located at the base address identified during the linking process. The secondary symbol tables are offset for use when the software program is relocated in memory. When the software is executing, the debugger examines the program counter to determine which of the symbol tables in the symbol table set to use. Each of the symbol tables contains symbols spanning a range of addresses. The debugger searches each of the symbol tables in the symbol table set to identify a symbol table whose range of addresses includes the address pointed to by the program counter. The debugger then selects that symbol table.

Automatic symbol table selection thus greatly benefits computer programmers during debugging by removing the task of manually offsetting symbol tables when programs are relocated in computer memory. These benefits are increased in instances when programs are frequently relocated, such as when programs move themselves in memory, a regular occurrence in embedded computer systems. For example, software (or more accurately in this instance, firmware) is often stored in read-only memory (ROM), then copied into random-access memory (RAM) for execution. Firmware which performs a computer self test also must move itself about in RAM during memory tests to avoid overwriting itself. Automatic symbol table selection allows a program to be moved around in memory without stopping to manually change a symbol table offset. This reduces the likelihood of error as well as simplifying the process for the programmer.

Automatic symbol table selection provides perhaps the greatest benefits in a multi-cell computer system, in which the software may be relocated to a large number of memory locations which are known in advance, when the symbol tables are created. A multi-cell computer system includes a number of processing cells, each having one or more computer processors with supporting hardware such as input/output (I/O) controllers, busses, etc. Memory may be provided for each cell, or a single common memory may be provided for the entire multi-cell computer system, with a range of memory dedicated to each cell. In the latter case, software is loaded into memory at a different address for each cell, requiring a different offset for the software's symbol table for each cell. Multi-cell architecture raises the possibility that each cell is executing the same program at a different address (in the case in which cells share memory), or that the cells are executing different programs at the same address (in the case in which cells each have their own memory). Automatic symbol table selection allows a debugger to be used with a multi-cell computer system without calculating a different offset depending on the active cell.

Referring now to FIG. 1, an exemplary multi-cell computer 10 having a single shared global RAM and an attached debugger 11 are illustrated in block diagram form. The multi-cell computer 10 has eight cells 12, 14, 16, 20, 22, 24, 26, and 30. Each cell (e.g., 12) includes four processors (e.g., 32, 34, 36, and 40). Multi-cell computers (e.g., 10) may be used to perform multiple tasks substantially independently. For example, each cell may be running a different operating system and may be allocated to different clients. The various systems and components in the cells 12-30 preferably include the processors 32-40 and support circuitry, such as I/O controllers, busses, etc. However, automatic symbol table selection is not limited to use with multi- cell computers or with any specific cell configuration. Accordingly, the present invention should not be regarded as limited to the particular multi-cell computer 10 and debugger 11 illustrated and described herein.

The multi-cell computer 10 also includes ROM 42 in which firmware is stored and RAM 44 which is shared by the eight cells 12-30. The RAM 44 is divided into eight areas 46, 50, 52, 54, 56, 60, 62, and 64. Each cell (e.g., 12-30) is assigned a different area (e.g., 46-64) in the RAM 44, each area having a different starting address. When a firmware program in ROM 42 is to be executed by a cell (e.g., 12) in the multi-cell computer 10, it is copied from the ROM 42 to the area (e.g., 46) in RAM 44 dedicated to the cell (e.g., 12). Thus, if the firmware was linked with its address in ROM 42 in mind, copying or relocating it to an area 46 in RAM 44 changes its base address. This requires an offset to be added to the addresses in a symbol table created for the firmware program.

As discussed above, the debugger 11 may comprise either a hardware device physically connected to the multi-cell computer system 10 by a cable 66, or a software program executing within the multi-cell computer system 10. The debugger 11 automatically selects the proper symbol table for firmware executing in the multi-cell computer system 10 without requiring a user to manually calculate and enter offsets.

Referring now to FIG. 2, a preferred exemplary multi-cell computer 70 and a debugger 71 are illustrated in block diagram form. The preferred multi-cell computer 70 has eight cells 72, 74, 76, 80, 82, 84, 86, and 90. Each cell (e.g., 72) includes four processors (e.g., 92, 94, 96, and 100). Each cell (e.g., 72) includes a ROM (e.g., 102) and a RAM (e.g., 104). The ROM (e.g., 102) and RAM (e.g., 104) on each cell use the same physical addresses. Multiple cells (e.g., 72 and 74) may be grouped together in a protection domain 112 . For example, if one client is using cells 1 72 and 2 74, they are grouped together in a protection domain, and the remaining cells 76-90 may be grouped in other protection domains for other clients. Cells (e.g., 72 and 74) grouped in a protection domain 112 share their RAM's 104 and 110 by interleaving them to create a single global memory for the protection domain 112.

Each cell 72 and 74 in the protection domain 112 can access the entire global memory, so care must be taken to prevent cells 72 and 74 from overwriting each other's programs and data. Thus, programs copied from the cells' ROM's 102 and 106 are relocated from the base addresses in ROM. For example, if each cell 72 and 74 is to execute a program stored at address 0 in their ROM's 102 and 106, they first copy the programs into the global memory. However, they cannot both copy the program to location 0 in the memory. Cell 1 72 may copy the program from its ROM 102 to address 1000 in the memory, and cell 2 74 may copy the program from its ROM 106 to address 2000 in the memory. When debugging these programs, the debugger will need to use a symbol table with an offset of 1000 for the program from the ROM 102 in cell 1 72, and an offset of 2000 for the program from the ROM 106 in cell 2 74.

Both of these exemplary multi-cell computer configurations benefit from automatic symbol table selection. An exemplary preferred symbol table set 130 enabling automatic symbol table selection is illustrated in FIG. 3. A symbol table set consists of one or more base symbol tables 132 and one or more secondary, or offset, symbol tables 134 and 136. Each secondary symbol table 134 and 136 in this preferred embodiment is created for a specific cell. The symbol table set 130 may consist of a single file containing all the symbol tables 132-136, or it may consist of independent symbol table files accessible by the debugger.

To create the symbol table set 130, the offsets to be used for each symbol table must be known in advance. since will be used in advance for each cell. Several secondary symbol tables may be created to provide a wide selection of relocation options for each cell during execution.

A secondary symbol table may consist of as little as a reference to a base symbol table, an offset, and a cell identification indicating for which cell the secondary symbol table is intended. However, a preferred secondary symbol table (e.g., 134 and 136) includes all the symbols of a base symbol table in order to increase access speed, as well as an offset, the upper and lower address of the symbols to indicate the range of addresses spanned by the secondary symbol table, and other flags as illustrated in FIG. 3.

This exemplary symbol table set 130 includes one base symbol table 130, named ‘BASE_CELL’, and two secondary symbol tables 134 and 136, named ‘RELOC_CELL1’ and ‘RELOC_CELL2’. Each symbol table 132-136 includes an indication 140, 142, and 144 of the number of symbols in the table. An offset 146, 150, and 152 in the symbol tables 132-136 indicates the address offset for the relocated software. A lowest and highest address 154 and 156, 160 and 162, and 164 and 166 indicate the range of addresses spanned by each symbol table 132, 134, and 136, respectively. A base flag and a relocated flag 170 and 172, 174 and 176, and 180 and 182 for each symbol table 132, 134, and 136, respectively, indicate whether the symbol table is a base symbol table or a secondary, relocated, symbol table. An auto flag 184, 186, and 190 indicates whether the symbol table may be selected automatically. An enabled flag 192, 194, and 196 indicates when the symbol table is selected, or active. Each secondary symbol table 134 and 136 contains an indication 200 and 202 of the cell for which it is intended. Finally, each symbol table 132, 134, and 136 contains the symbols 204, 206, and 210 for the software.

Referring now to FIG. 4, the automatic symbol table selection process for the multi-cell computer 10 and 70 and debugger 11 and 71 using the symbol table set 130 will be discussed. Note that in this exemplary preferred embodiment, the debugger performs the automatic symbol table selection. However, any processor with access to the program counter, the active cell number, and the memory in the multi-cell computer 10 and 70 containing the software and the symbol table set could perform the automatic symbol table selection.

Each time the software execution stops 220 and control returns to the debugger, the debugger automatically selects the appropriate symbol table. This allows software to be moved within memory during execution without manually changing symbol tables. The debugger first examines the program counter to determine 222 whether it points to an address within the base symbol table (e.g., 132). If it does, the debugger activates 224, or selects, the base symbol table. If the program counter does not point to an address within the base symbol table (e.g., 132), the debugger loops through the secondary, or relocated, symbol tables to find the appropriate one. The debugger first sets 226 a symbol table pointer Rsym to point at the first secondary symbol table (e.g., 134). The debugger then checks 230 to see if Rsym is pointing to a valid symbol table, or whether Rsym has been advanced past the end of the symbol table set 130. If Rsym is not pointing to a valid symbol table, normal processing in the debugger continues 232 and no symbol table is selected. If Rsym is pointing to a valid symbol table, the debugger examines the program counter to determine 234 whether it points to an address within the secondary symbol table referred to by Rsym. (The debugger may check flags such as relocated 176 and auto 186 before checking the program counter, as will be discussed below.) If the program counter does not point to an address within the secondary symbol table referred to by Rsym, Rsym is set 236 to point at the next symbol table. The loop then continues by the debugger checking 230 to see if Rsym is pointing to a valid symbol table. If the program counter does point to an address within the secondary symbol table referred to by Rsym, the debugger selects 240 the secondary symbol table referred to by Rsym, and normal processing in the debugger continues 232.

Exemplary program code executed by the debugger 11 and 71 to automatically select a symbol table is listed below.

1 void
2 SymbolTableC::symbolSetCurrent(int cell_, u64_t pc_)
3 {

| | | |
|---|---|---|
| 4 | list< SymbolTblS>::iterator | symTblPtr; |
| 5 | SymbolTblS | symTbl; |
| 6 | | |
| 7 | if(symAutoMode == 0) | |

| | | |
|---|---|---|
| 8 | return; | // not enabled |

| | | |
|---|---|---|
| 9 | for( | symTblPtr = symbolTables.begin( ) ; |

| | |
|---|---|
| 10 | symTblPtr != symbolTables.end( ) ; |
| 11 | ++symTblPtr) { |

| | | |
|---|---|---|
| 12 | symTbl = &* symTblptr; | // sym table to check |

| | |
|---|---|
| 13 | if(!(symTbl−>flags & SymbolTblS::SYM_TBL_BASE)) |

| | | |
|---|---|---|
| 14 | continue; | // not a base sym table |

| | |
|---|---|
| 15 | if(!(symTbl−>flags & SymbolTblS::SYM_TBL_AUTO)) |

| | | |
|---|---|---|
| 16 | continue; | // not enable for auto |

| | |
|---|---|
| 17 | if(symTbl−>lowest > pc_ \|\| symTbl−>highest < pc_) |

| | | |
|---|---|---|
| 18 | continue; | // pc not in table |

| | | |
|---|---|---|
| 19 | setAutoEnabled(&*symTbl) ; | // enable this, |
| 20 | | // disable others |

| | | |
|---|---|---|
| 21 | return; | // pc in a base symbol table |

| 22 | } | |
|---|---|---|
| 23 | for( | symTblPtr = symbolTables.begin( ) ; |
| 24 | | symTblPtr != symbolTables.end( ) ; |
| 25 | | ++symTblPtr) { |

| | | |
|---|---|---|
| 26 | symTbl = &*symTblPtr; | // sym table to check |

| | |
|---|---|
| 27 | if(!(symTbl−>flags & SymbolTblS::SYM_TBL_RELOC)) |

| | | |
|---|---|---|
| 28 | continue; | // not a relocated symtable |

| | |
|---|---|
| 29 | if(symTbl−>cell != cell_) |

| | | |
|---|---|---|
| 30 | continue; | // found table for cell |

| | |
|---|---|
| 31 | if(symTbl−>lowest > pc_ \|\| symTbl−>highest < pc_) |

| | | |
|---|---|---|
| 32 | continue; | // pc not in table |

| | | |
|---|---|---|
| 33 | setAutoEnabled(&*symTbl) ; | // enable this, |
| 34 | | // disable others |
| 35 | return; | |

| | |
|---|---|
| 36 | } |

37 }
38
39 //
40 // disable all base symbol tables and relocated symbol
41 // tables except enable_
42 //
43 void
44 SymbolTableC::setAutoEnabled(SymbolTblS *enable_)
45 {

| | | |
|---|---|---|
| 46 | list< SymbolTblS>::iterator | symTblPtr; |
| 47 | SymbolTblS | *symTbl; |
| 48 | | |

| | | |
|---|---|---|
| 49 | for( | symTblPtr = symbolTables.begin( ) ; |
| 50 | | symTblPtr != symbolTables.end( ) ; |
| 51 | | ++symTblPtr) { |

| | | |
|---|---|---|
| 52 | symTbl = &*symTblPtr; | // sym table to check |
| 53 | if(symTbl == enable_) | { |

| | |
|---|---|
| 54 | symTbl−>flags &= ˜SymbolTblS::SYM_DISABLED; |
| 55 | symTbl−>flags \|= SymbolTblS::SYM_ENABLED; |
| 56 | continue; |

| | |
|---|---|
| 57 | } |
| 58 | symTbl−>flags &= SymbolTblS::SYM_ENABLED; |
| 59 | symTbl−>flags \|= SymbolTblS::SYM_DISABLED; |

| | |
|---|---|
| 60 | } |

61 }

The first function above, symbolSetCurrent, beginning on line 1, selects the proper symbol table. The second function, setAutoEnabled, beginning on line 43, (called by symbolSetCurrent) sets the enabled flag (e.g., 192, 194, or 196) for the selected symbol table so that the debugger uses the selected symbol table. These functions are preferably executed by the debugger each time it transitions from an executing mode to a command mode, such as the user typing control-c to stop the debugger, or after a line of code is executed or a breakpoint has been reached and execution halts.

The active cell number and the program counter for the active processor in the cell are passed to the symbolSetCurrent function as parameters. A for loop (lines 9-22) is used to examine the base symbol tables. An if statement (line 13) first verifies that the symbol table being examined is a base symbol table, and if not, the loop continues (line 14) with the next symbol table. Another if statement (line 15) verifies that the auto flag (e.g., 184) is set to enable automatic symbol table selection. If not, the loop continues (line 16) with the next symbol table. Another if statement (line 17) then checks whether the program counter is pointing to an address between the lowest and highest addresses (e.g., 154 and 156) spanned by the symbol table. If so, the program counter is pointing within this symbol table and the setAutoEnabled function is called (line 19) to cause the debugger to use this symbol table. Finally, a return statement (line 21) ends execution of the function since the proper symbol table has been selected.

If none of the base symbol tables were identified and selected, another for loop (lines 23-36) is used to examine the relocated symbol tables. An if statement (line 27) first verifies that the symbol table being examined is a relocated symbol table, and if not, the loop continues (line 28) with the next symbol table. Another if statement (line 29) verifies that the cell identification flag (e.g., 200 or 202) matches the active cell number, to make sure that this symbol table was created for the active cell. If not, the loop continues (line 30) with the next symbol table. Another if statement (line 31) then checks whether the program counter is pointing to an address between the lowest and highest addresses (e.g., 160 and 162, or 164 and 166) spanned by the symbol table. If so, the program counter is pointing within this symbol table and the setAutoEnabled function is called (line 33) to cause the debugger to use this symbol table. Finally, a return statement (line 35) ends execution of the function since the proper symbol table has been selected.

The setAutoEnabled function (lines 43-61) enables the selected symbol table and disables all others by cycling through all the symbol tables in the symbol table set 130 and setting the enabled flags (e.g., 192, 194, and 196) and disabled flags (not shown in FIG. 3). A pointer to the selected symbol table is passed to the setAutoEnabled function as a parameter from the symbolSetCurrent function. A for loop (lines 49-60) cycles through all the symbol tables in the symbol table set 130. If the symbol table being examined in the loop matches (line 53) that selected by symbolSetCurrent, the enabled flag (e.g., 192, 194, or 196) is set (line 55), and the loop continues (line 56) with the next symbol table. If the symbol table being examined in the loop does not match that selected by symbolSetCurrent, the enabled flag (e.g., 192, 194, or 196) is cleared (line 58), and the loop continues with the next symbol table.

Symbol table sets may be created for any type of software, and multiple symbol table sets may be used with one system. For example, different symbol table sets may be created for operating system software, firmware, and user applications. Note also that the symbol table contents may vary as desired. For example, the auto flags (e.g., 184, 186, and 190) allow symbol tables in a symbol table set to be excluded from the automatic symbol table selection, but that they are not necessary for automatic symbol table selection.

As noted above, automatic symbol table selection is not limited to the computer systems described herein. For example, automatic symbol table selection may also be used in an architectural simulator, in which a computer platform is simulated by software, usually during the development of a new hardware platform. Automatic symbol table selection in an architectural simulator allows software developers to write and debug software while the new computer platform is being developed. This allows stable software to be released for a new computer platform as soon as the hardware is released. In this exemplary embodiment, debugging tools which utilize symbol tables are used to debug software which is executed on the architectural simulator. Automatic symbol table selection is very beneficial when used with architectural simulators as well as when used with physical computer systems. For example, an architectural simulation of a multi-cell computer system presents the same symbol table selection difficulties as those presented in a physical multi-cell computer system as described above.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of selecting a symbol table, comprising:
providing a plurality of symbol tables in a computer system, said computer system having an address pointer, each of said symbol tables encompassing a range of addresses;
identifying at least one of said plurality of symbol tables within whose range of addresses said address pointer is pointing; and
selecting said at least one of said plurality of symbol tables.

2. The method of claim 1, wherein a debugger connected to said computer system performs said identifying and said selecting of said at least one of said plurality of symbol tables.

3. The method of claim 2, wherein said identifying and said selecting is performed each time said debugger transitions from an executing mode to a command mode.

4. The method of claim 1, wherein said computer system performs said identifying and said selecting of said at least one of said plurality of symbol tables.

5. The method of claim 1, wherein said address pointer comprises a pointer to a memory location containing instructions to be executed.

6. The method of claim 5, wherein said pointer comprises a program counter.

7. The method of claim 1, wherein said computer system comprises a plurality of cells, each of said cells comprising a processing unit having at least one computer processor, the method further comprising identifying an active cell among said plurality of cells, wherein said symbol table is being selected for said active cell.

8. The method of claim 7, wherein said plurality of symbol tables includes at least one base symbol table and a plurality of secondary symbol tables, and wherein said identifying said at least one of said plurality of symbol tables comprises:
examining said at least one base symbol table to determine whether said address pointer is pointing within said at least one base symbol table;
and
examining at least one of said plurality of secondary symbol tables to determine whether said address pointer is pointing within said at least one of said plurality of secondary symbol tables, wherein said at least one of said plurality of secondary symbol tables is associated with said active cell.

9. The method of claim 8, wherein said plurality of symbol tables are contained in a symbol table set, and wherein each of said plurality of secondary symbol tables comprise a reference to a base symbol table, a cell identifier, and an address offset specifying an offset from said base symbol table.

10. The method of claim 8, wherein said at least one base symbol table is examined before said at least one of said plurality of secondary symbol tables is examined.

11. The method of claim 8, wherein said at least one of said plurality of secondary symbol tables is only examined if said address pointer is not pointing within said at least one base symbol table.

12. The method of claim 8, wherein said examining at least one of said plurality of secondary symbol tables comprises checking a cell identifier within each of said plurality of secondary symbol tables to determine whether each of said plurality of secondary symbol tables is associated with said active cell, and examining only tables within said plurality of secondary symbol tables which are associated with said active cell to determine whether said tables which are associated with said active cell should be selected.

13. The method of claim 1, wherein said at least one of said plurality of symbol tables is selected by marking said at least one of said plurality of symbol tables as active.

14. The method of claim 13, further comprising a debugger using a symbol table among said plurality of symbol tables which is marked as active.

15. The method of claim 1, wherein said computer system comprises an architectural simulator.

16. An apparatus for automatically selecting a symbol table in a computer having a program counter and a plurality of symbol tables, the apparatus comprising:
a) at least one computer readable storage medium; and
b) computer readable program code stored on the at least one computer readable storage medium, the computer readable program code comprising:
i) code for identifying one of said plurality of symbol tables wherein said program counter in said computer contains an address within said one of said plurality of symbol tables; and
ii) selecting said one of said plurality of symbol tables.

17. The apparatus of claim 16, wherein each of said plurality of symbol tables includes symbols stored within an address range, and wherein said code for identifying said one of said plurality of symbol tables comprises determining whether said program counter contains an address within said address range for said one of said plurality of symbol tables.

18. The apparatus of claim 16, wherein said code for identifying one of said plurality of symbol tables comprises code for determining whether said program counter contains an address within a base symbol table in said plurality of symbol tables.

19. The apparatus of claim 16, wherein said code for identifying one of said plurality of symbol tables comprises code for determining whether said program counter contains an address within an offset symbol table in said plurality of symbol tables.

20. The apparatus of claim 19, wherein said computer comprises a plurality of processing cells.

21. The apparatus of claim 20, wherein said code for identifying one of said plurality of symbol tables further comprises code for determining whether a cell identifier in said offset symbol table refers to one of said plurality of processing cells which is executing said computer readable program code.

22. The apparatus of claim 16, further comprising code for determining whether said one of said plurality of symbol tables is enabled for automatic selection.

23. A debugging apparatus, comprising:
a computer having a plurality of symbol tables stored thereon;
a debugger connected to said computer; and
automatic symbol table selection means for automatically selecting at least one of said plurality of symbol tables in said computer for said debugger.

24. The debugging apparatus of claim 23, wherein said computer comprises a plurality of processing cells.

25. An apparatus for automatically selecting a symbol table in a computer having a plurality of processing cells and having a plurality of symbol tables stored thereon, each of said plurality of symbol tables having a cell identification to indicate for which of said plurality of processing cells it is intended, the apparatus comprising:
a) at least one computer readable storage medium; and
b) computer readable program code stored on said at least one computer readable storage medium, the computer readable program code comprising code for selecting at least one symbol table which is intended for use with the processing cell which is executing said computer readable program code.
